(19) United States
(12) Patent Application Publication
(10) Pub. No.: US 2021/0138314 A1
(43) Pub. Date: May 13, 2021

(54) METHOD FOR PRODUCING A GOLF CLUB HEAD HAVING A WEIGHT BLOCK

(71) Applicant: FUSHENG PRECISION CO., LTD, Taipei (TW)

(72) Inventors: Ta-Chien Cheng, Taipei (TW); Yun-Qi Tang, Zhongshan City (CN); Ji-Feng Chen, Danzhou City (CN); Bao-Bin Li, Zhongshan City (CN); Zhi-Ke Wang, Zhongshan City (CN)

(21) Appl. No.: 17/011,072

(22) Filed: Sep. 3, 2020

(30) Foreign Application Priority Data
Nov. 12, 2019 (CN) 201911098438.7

(51) Int. Cl. A63B 53/04; B23K 26/21; B23K 35/32; B23K 9/24; B23K 9/00

(52) U.S. Cl. CPC A63B 53/0408; B23K 26/21; A63B 53/0416; B23K 9/24; B23K 9/0026; B23K 35/325

(57) ABSTRACT

A method for producing a golf club head having a weight block includes providing a club head body formed of a titanium alloy. The club head body includes a surface having a coupling portion. A weight block formed of a tungsten-copper-nickel alloy is provided and includes 1-17 wt % of copper and 6-37 wt % of nickel, with the balance being tungsten. The tungsten-copper-nickel alloy has a specific weight of 12-17 g/cm³. The weight block is placed into the coupling portion of the club head body, and a welding heat source is applied to abutting portions of the weight block and the coupling portion to proceed with fusion welding, tightly engaging the weight block with the coupling portion of the club head body.

### CROSS REFERENCE TO RELATED APPLICATIONS

The application claims the benefit of China application serial No. 201911098438.7, filed on Nov. 12, 2019, and the entire contents of which are incorporated herein by reference.

### BACKGROUND OF THE INVENTION

### 1. Field of the Invention

The present invention relates to a method for producing a golf club head and, more particularly, to a method for producing a golf club head having a weight block.

### 2. Description of the Related Art

The industry generally uses a light material, such as a titanium alloy, to form a club head body. The club head body is then coupled with a weight block made of a material with a high specific weight, such that the overall weight of the golf club head is reduced while lowering the center of gravity of the golf club head. For example, Taiwan Patent No. 1227675 discloses use of a currently available tungsten-iron-nickel alloy to form the weight block.

However, when a fusion welding method is used to weld a weight block of the currently available tungsten-iron-nickel alloy to a club head body of a titanium alloy, a ferro-tungsten acicular structure is formed at the weld, and weld cracking is apt to occur. To engage the weight block with the club head body, brazing is required while using expensive brazing agents, leading to an increase in the production costs of the golf club head.

Thus, improvement to the current method for producing a golf club head having a weight block is still required.

### SUMMARY OF THE INVENTION

To solve the above disadvantage, an objective of the present invention is to provide a method for producing a golf club head having a weight block, such that weld cracking is less likely to occur during production processing.

Another objective of the present invention is to provide a method for producing a golf club head having a weight block without using brazing agents.

As used herein, the term “a” or “an” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

A method for producing a golf club head having a weight block according to the present invention includes providing a club head body formed of a titanium alloy. The club head body includes a surface having a coupling portion. A weight block formed of a tungsten-copper-nickel alloy is provided and includes 1-17 wt % of copper and 6-37 wt % of nickel, with the balance being tungsten. The tungsten-copper-nickel alloy has a specific weight of 12-17 g/cm³. The weight block is placed into the coupling portion of the club head body, and a welding heat source is applied to abutting portions of the weight block and the coupling portion to proceed with fusion welding, tightly engaging the weight block with the coupling portion of the club head body.

Thus, the method for producing a golf club head having a weight block according to the present invention uses welding fusion to tightly engage the weight block formed of the tungsten-copper-nickel alloy with the club head body made of the titanium alloy. The titanium atoms of the club head body diffuse towards the weight block, and the copper atoms of the weight block diffuse towards the club head body. Thus, the final product of the golf club head is less likely to crack, increasing the yield of the golf club head. Furthermore, the method for producing a golf club head having a weight block according to the present invention uses welding fusion to tightly engage the weight block formed of the tungsten-copper-nickel alloy with the club head body made of the titanium alloy. Thus, the expensive brazing agents demanded in current methods for producing a golf club head having a weight block are not required during the fusion welding in the method according to the present invention to thereby reduce the production costs of the golf club head.

In an example, the tungsten-copper-nickel alloy includes 1-3 wt % of copper and 6-8 wt % of nickel, and the specific weight of the tungsten-copper-nickel alloy is 17 g/cm³. In another example, the tungsten-copper-nickel alloy includes 8-12 wt % of copper and 19-23 wt % of nickel, and the specific weight of the tungsten-copper-nickel alloy is 14 g/cm³. In a further example, the tungsten-copper-nickel alloy includes 13-17 wt % of copper and 33-37 wt % of nickel, and the specific weight of the tungsten-copper-nickel alloy is 12 g/cm³. Thus, a worker can select tungsten-copper-nickel alloys of different specific weights to form the weight block, thereby fulfilling different user needs.

In an example, the titanium alloy has a specific weight of 12-17 g/cm³. Thus, the overall weight of the final product of the golf club head can be effectively reduced.

In an example, a tungsten electrode is used to form an electric arc. As an example, the tungsten electrode forms the electric arc between the weight block and the coupling portion under the protection of an inert gas. Alternatively, the tungsten electrode and a plasma together form the electric arc. The electric arc is used as a welding heat source for fusion welding. Thus, by using the electric arc as the welding heat source, a narrow, deep weld can be formed while reducing the metallographic change in the heat affected zone.

In an example, the tungsten electrode forms the electric arc at a current intensity of 70-90 amperes. Thus, the fusion welding can be effectively carried out.

In another example, a laser beam is used as the welding heat source for the fusion welding. Thus, by using the laser beam as the welding heat source, a narrow, deep weld can be formed while reducing the metallographic change in the heat affected zone.

In an example, the laser beam used as the welding heat source has a power of 1600-2200 W. Thus, the fusion welding can be effectively carried out.

In an example, the coupling portion of the club head body includes an opening and an inner wall. The inner wall of the coupling portion extends towards the opening and protrudes beyond the outer face of the club head body to form a lip which extends around the opening. The weight block includes a peripheral face and an end face. A chamfered face is interconnected between the peripheral face and the end face. When the weight block is placed in the coupling portion of the club head body, the chamfered face of the weight block faces the inner wall of the coupling portion, and the chamfered face and the inner wall form a filling space. Thus, the engaging area between the weight block and the weld resulting from fusion welding is increased to effectively increase the engaging strength between the weight block and the club head body.

In an example, when the weight block is placed in the coupling portion of the club head body, the chamfered face and the inner wall have an inverted angle of 30-60° therebetween. Thus, the engaging area between the weight block and the weld resulting from fusion welding is increased to effectively increase the engaging strength between the weight block and the club head body.

In an example, the surface of the club head body is an outer surface of the club head body, wherein a top face of the lip has a first height from the outer surface of the club head body, wherein the lip has a first width, wherein the chamfered face and the peripheral face are interconnected at a side edge, wherein the chamfered face and the end face are interconnected at a top edge, wherein the side edge has a second height from the end face, wherein the top edge and the peripheral face have a second width therebetween, and wherein the first height, the first width, the second height, and the second width are identical. Thus, the lip can more easily fill the filling space after melting, achieving optimal welding infiltration and optimal engaging strength.

The present invention will become clearer in light of the following detailed description of illustrative embodiments of this invention described in connection with the drawings.

### BRIEF DESCRIPTION OF THE DRAWINGS

FIG. 1 is an exploded, perspective view of a final product of a golf club head of an embodiment according to the present invention.

FIG. 2 is a cross sectional view taken along section line 2-2 of FIG. 1.

FIG. 3 is a cross sectional view of the golf club head after coupling and taken along section line 2-2 of FIG. 1.

FIG. 4 is a cross sectional view of the final product of the golf club head of FIG. 3.

FIG. 5 is a metallographic diagram of a weld of a final product of a golf club head of group B2 in trial (B).

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

With reference to FIG. 1, a method for producing a golf club head having a weight block of an embodiment according to the present invention comprises providing a club head body 1 and tightly engaging a weight block 2 formed of a tungsten-copper-nickel alloy with the club head body 1 by fusion welding, thereby forming a final product of a golf club head. It is worth noting that the final product of the golf club head can be a wood club or an iron club. The present invention is not limited in this regard.

Specifically, the club head body 1 may be made of a titanium alloy, such as 811 titanium alloy shown in TABLE 1 or 6-4 titanium alloy shown in TABLE 2. The titanium alloy has a specific weight of 12-17 g/cm³. Thus, the overall weight of the final product of the golf club head can be effectively reduced.

TABLE 1

| | Aluminum | Vanadium | Molybdenum | Titanium |
|---|---|---|---|---|
| Composition | (Al) | (V) | (Mo) | (Ti) |
| Ratio | 8% | 1% | 1% | Balance |

TABLE 2

| | Aluminum | Vanadium | Titanium |
|---|---|---|---|
| Composition | (Al) | (V) | (Ti) |
| Ratio | 6% | 4% | Balance |

The club head body 1 includes a coupling portion 11 which can be disposed on an outer surface 12 or an inner surface of the club head body 1 according to need. The present invention is not limited in this regard. As shown in FIG. 1, the coupling portion 11 is a coupling groove recessed in the outer surface 12 of the club head body 1, and an opening 111 is formed in the outer surface 12. An operator can place the weight block 2 through the opening 111 into the coupling portion 11. Furthermore, the coupling portion 11 is preferably on the sole S of the club head body 1. Thus, the center of gravity of the final product of the club head body can be effectively lowered by the weight block 2 received in the coupling portion 11.

The tungsten-copper-nickel alloy forming the weight block 2 may comprise 1-17 wt % of copper and 6-37 wt % of nickel, with the balance being tungsten, such that the tungsten-copper-nickel alloy has a specific weight of 12-17 g/cm³. For example, when the specific weight of the tungsten-copper-nickel alloy is 17 g/cm³, the tungsten-copper-nickel alloy may comprise 1-3 wt % of copper and 6-8 wt % of nickel, with the balance being tungsten. When the specific weight of the tungsten-copper-nickel alloy is 14 g/cm³, the tungsten-copper-nickel alloy may comprise 8-12 wt % of copper and 19-23 wt % of nickel, with the balance being tungsten. When the specific weight of the tungsten-copper-nickel alloy is 12 g/cm³, the tungsten-copper-nickel alloy may comprise 13-17 wt % of copper and 33-37 wt % of nickel, with the balance being tungsten.

By the above composition ratio, the tungsten-copper-nickel alloy can have a Rockwell hardness of about 95 HRB-25 HRC, a tensile strength about 520-880 MPa, and an elongation of about 4-7%. The hardness of the tungsten-copper-nickel alloy is similar to the hardness of currently available tungsten-copper-nickel alloys.

The weight block 2 has a configuration generally corresponding to the coupling portion 11, such that when the weight 2 is placed in the coupling portion 11, the peripheral face 21 of the weight block 2 abuts the inner wall 112 of the coupling portion 11. Furthermore, the end face 22 of the weight block 2 is exposed outside of the opening 111 and is approximately flush with the outer surface 12 of the club head body 1.

Then, the operator can proceed with fusion welding at abutting portions of the weight block 2 and the coupling portion 11. Specifically, a welding heat source is applied to the abutting portions of the weight block 2 and the coupling portion 1. At this time, since the melting point of the titanium alloy is lower than the melting point of the tungsten-copper-nickel alloy, only a portion of the club head body 1 adjacent to the abutting portion can melt to form a molten metal liquid which leaks inbetween the inner wall 112 of the coupling portion 11 and the peripheral wall 21 of the weight block 2. After the molten metal liquid cools down and solidifies, a weld is formed between the club head body 1 and the weight block 2.

For example, the operator can proceed with tungsten inert gas welding (TIG welding). Namely, an electric arc is formed by a tungsten electrode under the protection of an inert gas (such as argon, helium, or a mixture of argon and helium), and the electric arc is used as the welding heat source. Alternatively, the operator can proceed with plasma welding. Namely, the tungsten electrode and a plasma gas together form the electric arc which is used as the welding heat source. Alternatively, the operator can proceed with laser beam welding. Namely, a laser beam is used as the welding heat source. These can be appreciated by one having ordinary skill in the art and are, therefore, not described to avoid redundancy.

Furthermore, when a portion of the club head body 1 forms the molten metal liquid, the operator can also melt a welding rod (not shown), such that the portion of the club head body 1 adjacent to the abutting portion and the welding rod can together form the molten metal liquid. As an example, the welding rod can also be made of the titanium alloy, such that an excellent engagement can be provided between the welding rod and the club head body 1.

It is worth noting that to increase the engaging strength between the weight block 2 and the club head body 1, the inner wall 112 of the coupling portion 111 extends towards the opening 111 and protrudes beyond the outer surface 12 of the club head body 1 to form a lip 113 which extends around the opening 111, as shown in FIGS. 1-3. Furthermore, the weight block 2 includes a chamfered face 23 interconnected between the peripheral face 21 and the end face 22, such that when the weight block 2 is placed in the coupling portion 11 of the club head body 1, the chamfered face 23 of the weight block 2 faces the inner wall 112 of the coupling portion 11, and the chamfered face 23 and the inner wall 112 have an inverted angle therebetween. The inverted angle may be in a range of 30-60°. Thus, the chamfered face 23 and the inner wall 112 form a filling space F extending annularly. Therefore, when proceeding with the fusion welding, the lip 113 and the welding rod together form the molten metal liquid which flows into and fills the filling space F. After the molten metal fluid cools down and solidifies, a weld is formed between the club head body 1 and the weight block 2. In this case, since the engaging face between the weld and the weight block 2 has a larger engaging area, the engaging strength between the weight block 2 and the club head body 1 can be effectively increased.

In this embodiment, a top face 114 of the lip 113 has a first height H1 from the outer surface 12 of the club head body 1, and the lip 113 has a first width W1. The first height H1 and the first width W1 can be approximately identical, and the inverted angle is 45°. Furthermore, the chamfered face 23 and the peripheral face 21 are interconnected at a side edge 231, and the chamfered face 23 and the end face 22 are interconnected at a top edge 232. The side edge 231 has a second height H2 from the end face 22, and the top edge 232 and the peripheral face 21 have a second width W2 therebetween. The second height H2 and the second width W2 can also be approximately identical. It is worth noting that the first height H1, the first width W1, the second height H2, and the second width W2 can also be identical. Thus, the lip 113 can more easily fill the filling space F after melting, achieving optimal welding infiltration and optimal engaging strength.

To prove that the method for producing a golf club head having a weight block of this embodiment can indeed tightly engage the weight block 2 with the club head body 1 while forming the final product of the golf club head, the following trials are conducted.

(A) Composition Ratio of the Tungsten-Copper-Nickel Alloy

This trial is carried out using weight blocks 2 formed of alloys shown in TABLE 3. Then, the weight blocks 2 and the club head bodies 1 undergo fusion welding. Next, the tensile strength of the final product of the golf club head of each group is tested.

TABLE 3

| | Tungsten | Copper | Nickel | Tensile strength |
|---|---|---|---|---|
| Group | (%) | (%) | (%) | (MPa) |
| A0 | 90 | 10 | 0 | — |
| A1 | 90 | 9 | 1 | 820 |
| A2 | 90 | 8 | 2 | 880 |
| A3 | 90 | 7 | 3 | 870 |

With reference to TABLE 3, although the weight block 2 formed of the tungsten-nickel alloy of group A0 can engage with the club head body 1 through fusion welding, the club head body 1 disengages from the weight block 2 in a subsequent grinding procedure. Namely, the engaging strength between the club head body 1 and the weight block 2 is not good. By contrast, the tensile strengths of the weight blocks 2 formed of the tungsten-copper-nickel alloys of groups A1-A3 after engaging with the club head bodies 1 can reach 820-880 MPa, and the group A2 has the best effect.

(B) Selection of Welding Methods

This trial includes selecting TIG welding as group B1 (the current intensity is 70-90 amperes), selecting plasma welding as group B2 (the current intensity is 70-90 amperes), and selecting laser welding as group B3 (the power is 1600-2200 W) to weld the weight blocks 2 and the club head bodies 1, respectively. According to the result, the tensile forces of groups B1-B3 are 1273 kfg, 1321 kfg, and 1072 kfg, respectively, showing that the plasma welding provides the best effect.

Next, the appearance of the final product of the golf club head of group B2 is checked, and it is found that both the weight block 2 and the weld resulting from welding have no obvious cracks. The metallographic diagram of the weld is shown in FIG. 5, with the lower left corner being the club head body 1 and with the upper right corner being the weight block 2. The heat affected zone Z between the club head body 1 and the weight block 2 has a width of about 0.3-1.5 mm, and a portion of the molten zone M of the club head body 1 is adjacent to the heat affected zone Z. Furthermore, the titanium atoms of the club head 1 diffuse towards the weight block 2, and the copper atoms of the club head 2 diffuse towards the club head body 1. This shows that the welding is a diffusion welding. Furthermore, the weld can be miscible and permeable with the club head body 1 and the weight block 2.

(C) Cannon Shot Tests

Ti-811 alloy (group C1) and Ti-6-4 alloy (group C2) are used to form club head bodies 1, respectively. Then, the club head bodies 1 and the weight blocks 2 undergo fusion welding. Next, cannon shot tests (shooting at a velocity of 50/s) are carried out on the final products of the golf club heads of groups C1 and C2. The results show that the final products of the golf club heads of groups C1 and C2 can withstand 3,500 times and 3,300 times of shooting, respectively. No cracks are found in the weight blocks 2 and the welds.

In view of the foregoing, the method for producing a golf club head having a weight block according to the present invention uses welding fusion to tightly engage the weight block 2 formed of the tungsten-copper-nickel alloy with the club head body 1 made of the titanium alloy. The titanium atoms of the club head body 1 diffuse towards the weight block 2, and the copper atoms of the weight block 2 diffuse towards the club head body 1. Thus, the final product of the golf club head is less likely to crack, increasing the yield of the golf club head.

Furthermore, the method for producing a golf club head having a weight block according to the present invention uses welding fusion to tightly engage the weight block 2 formed of the tungsten-copper-nickel alloy with the club head body 1 made of the titanium alloy. Thus, the expensive brazing agents demanded in current methods for producing a golf club head having a weight block are not required during the fusion welding in the method according to the present invention to thereby reduce the production costs of the golf club head.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A method for producing a golf club head having a weight block, comprising:
providing a club head body formed of a titanium alloy, wherein the club head body includes a surface having a coupling portion;
providing a weight block formed of a tungsten-copper-nickel alloy comprising 1-17 wt % of copper and 6-37 wt % of nickel, with the rest being tungsten, wherein the tungsten-copper-nickel alloy has a specific weight of 12-17 g/cm³; and
placing the weight block into the coupling portion of the club head body, and applying a welding heat source to abutting portions of the weight block and the coupling portion to proceed with fusion welding, tightly engaging the weight block with the coupling portion of the club head body.

2. The method for producing the golf club head having the weight block as claimed in claim 1, wherein the tungsten-copper-nickel alloy comprises 1-3 wt % of copper and 6-8 wt % of nickel, and the specific weight of the tungsten-copper-nickel alloy is 17 g/cm³.

3. The method for producing the golf club head having the weight block as claimed in claim 1, wherein the tungsten-copper-nickel alloy comprises 8-12 wt % of copper and 19-23 wt % of nickel, and the specific weight of the tungsten-copper-nickel alloy is 14 g/cm³.

4. The method for producing the golf club head having the weight block as claimed in claim 1, wherein the tungsten-copper-nickel alloy comprises 13-17 wt % of copper and 33-37 wt % of nickel, and the specific weight of the tungsten-copper-nickel alloy is 12 g/cm³.

5. The method for producing the golf club head having the weight block as claimed in claim 1, wherein the titanium alloy has a specific weight of 12-17 g/cm³.

6. The method for producing the golf club head having the weight block as claimed in claim 1, wherein the fusion welding includes using a tungsten electrode to form an electric arc between the weight block and the coupling portion, and wherein the electric arc is used as the welding heat source for the fusion welding.

7. The method for producing the golf club head having the weight block as claimed in claim 6, wherein an inert gas is used during the fusion welding for protection.

8. The method for producing the golf club head having the weight block as claimed in claim 6, wherein the electric arc is formed by the tungsten electrode and a plasma gas.

9. The method for producing the golf club head having the weight block as claimed in claim 6, wherein the tungsten electrode forms the electric arc at a current intensity of 70-90 amperes.

10. The method for producing the golf club head having the weight block as claimed in claim 1, wherein a laser beam is used as the welding heat source for the fusion welding.

11. The method for producing the golf club head having the weight block as claimed in claim 10, wherein the laser beam used as the welding heat source has a power of 1600-2200 W.

12. The method for producing the golf club head having the weight block as claimed in claim 1, wherein the coupling portion of the club head body includes an opening and an inner wall, wherein the inner wall of the coupling portion extends towards the opening and protrudes beyond the outer surface of the club head body to form a lip which extends around the opening, wherein the weight block includes a peripheral face and an end face, wherein a chamfered face is interconnected between the peripheral face and the end face, wherein when the weight block is placed in the coupling portion of the club head body, the chamfered face of the weight block faces the inner wall of the coupling portion, and wherein the chamfered face and the inner wall form a filling space.

13. The method for producing the golf club head having the weight block as claimed in claim 12, wherein when the weight block is placed in the coupling portion of the club head body, the chamfered face and the inner wall have an inverted angle of 30-60° therebetween.

14. The method for producing the golf club head having the weight block as claimed in claim 12, wherein the surface of the club head body is an outer surface of the club head body, wherein a top face of the lip has a first height from the outer surface of the club head body, wherein the lip has a first width, wherein the chamfered face and the peripheral face are interconnected at a side edge, wherein the chamfered face and the end face are interconnected at a top edge, wherein the side edge has a second height from the end face, wherein the top edge and the peripheral face have a second width therebetween, and wherein the first height, the first width, the second height, and the second width are identical.
